(19) United States
(12) Patent Application Publication
(10) Pub. No.: US 2004/0073627 A1
(43) Pub. Date: Apr. 15, 2004

(54) Patent or utility model information retrieval management system using the internet

(76) Inventor: Toshihiko Amano, Kanagawa-ken (JP)

Correspondence Address: MILES & STOCKBRIDGE PC, 1751 PINNACLE DRIVE, SUITE 500, MCLEAN, VA, 22102-3833, US

(21) Appl. No.: 10/467,833

(22) PCT Filed: Mar. 1, 2002
(86) PCT No.: PCT/JP02/01898

(30) Foreign Application Priority Data
Mar. 2, 2001 (JP) 2001-058848
Mar. 27, 2001 (JP) 2001-090756
Sep. 25, 2001 (JP) 2001-291365

(51) Int. Cl. G06F 15/16

(52) U.S. Cl. 709/217; 707/3

(57) ABSTRACT

A management system of patent or utility model information retrieval by Internet, connects a PC of a group or a subgroup to a server of a server management office by an Internet line, said PC accesses to said server, said server has a retrieval data base containing at least one of classification code data for a group, classification code data for a subgroup, and a classification code data for an individual, as well as an information data base of patent or utility model information, said retrieval data base and said information data base are retrieved upon request of retrieval for patent or utility model information by said PC and applied data of the patent or utility model information is issued to said PC, and said PC outputs the issued data.

### FIELD OF TECHNOLOGY

The present invention relates to a management system of patent or utility model information retrieval by the use of a computer and an Internet line.

### BACKGROUND ART

There is disclosed in Nikkei Open System No. 30, on page 260 (issued on Sep. 15, 1995) a patent information retrieval system in which, with respect to retrieval of patent and utility model information, a retrieval server is installed in each company so as to allow a user to attach a comment to an arbitrary part of a drawing or a writing. However, for this patent information retrieval system, a retrieval server has to be installed in each user company and an Internet line is not be utilized. There is also disclosed an application service provider (ASP) for conducting retrieval service of patent or utility model information by the use of the Internet line in Nikkei-Sangyo Shinbun (on the fifth page, dated Oct. 12, 2000). These two disclosed systems use as the classification codes to be attached to the patent and the utility model information only the IPC classification codes, the FI symbols, and the F term classification codes which are given in advance. Accordingly, for retrieving patent or utility model information, the user can use only the existing retrieving items, which results in a great deal of time and labor to obtain a desired piece of patent or utility model information.

With such existing classification codes, it is difficult to classify the patent and utility model information based on the technical information which is original with a user company (or a user). Moreover, in the above disclosed systems, the company (or the user) can not give and store on a data base classification codes related to the technical information which is characteristic of the company on the basis of the technical information which is original with the company. As a result, the company can not retrieve the patent or utility model information on the basis of its own classification codes.

### DISCLOSURE OF THE INVENTION

An object of the present invention is to provide a management system of patent or utility model information retrieval by the use of an Internet line, which allows attachment and storage of classification codes into an information retrieval server on the basis of the technical information original with a user company, so as to quickly provide patent or utility model information to the user by retrieving the information with these classification codes.

In order to achieve the above object, according to a first aspect of the invention, there is provided a management system of patent or utility model information retrieval through Internet, characterized in that:

a personal computer of a group or a subgroup is connected to a server of a server management office by the Internet line;

said personal computer accesses to said server;

said server has a retrieval data base containing at least one of classification code data for a group, classification code data for a subgroup, and a classification code data for an individual, as well as an information data base of patent or utility model information;

said retrieval data base and said information data base are retrieved upon request of retrieval for patent or utility model information by said personal computer and applied data of the patent or utility model information is issued to said personal computer; and

said personal computer outputs the issued data.

According to a second aspect of the invention, there is provided a management system of patent or utility model information retrieval through Internet, characterized in that:

a personal computer of a group or a subgroup is connected to a server of a server management office by the Internet line;

an identification code of said group or an identification code of said subgroup is automatically assigned at a gate of said group or said subgroup;

the identification code of said group or the identification code of said subgroup is accepted at a gate of said server management office;

said server of said server management office recognizes the identification code of said group or the identification code of said subgroup;

whereupon said personal computer accesses to said server;

said server has a retrieval data base containing at least one of classification code data for a group, comment data for a group, assessment code data for a group, classification code data for a subgroup, comment data for a subgroup, assessment code data for a subgroup, classification code data for an individual, comment data for an individual, and assessment code data for an individual, as well as an information data base of patent or utility model information;

said retrieval data base and said information data base are retrieved upon request of retrieval for patent or utility model information by said personal computer and applied data of the patent or utility model information is issued to said personal computer; and

said personal computer outputs the issued data.

According to a third aspect of the invention, there is provided a management system of patent or utility model information retrieval through Internet, characterized in that:

a personal computer of a group or a subgroup is connected to a server of a server management office by the Internet line;

said personal computer accesses to said server;

said server has a retrieval data base containing at least one of classification code data for a group, comment data for a group, assessment code data for a group, classification code data for a subgroup, comment data for a subgroup, assessment code data for a subgroup, classification code data for an individual, comment data for an individual, and assessment code data for an individual, as well as an information data base of patent or utility model information;

said retrieval data base and said information data base are retrieved upon request of retrieval for patent or utility model information by said personal computer and applied data of the patent or utility model information is issued to said personal computer; and

said personal computer outputs the issued data.

### BRIEF DESCRIPTION OF THE DRAWINGS

FIG. 1 is a diagram for schematically showing the configuration of a management system of patent or utility model retrieval by Internet according to a first embodiment of the present invention;

FIG. 2 is a diagram for schematically showing the configuration of a management system of patent or utility model retrieval by Internet according to a second embodiment of the present invention;

FIG. 3 is a diagram for schematically showing the configuration of a management system of patent or utility model retrieval by Internet according to a third embodiment of the present invention; and

FIG. 4 is a flowchart for showing a retrieving sequence in a management system of patent or utility model retrieval by Internet according to the present invention.

### DETAILED DESCRIPTION OF THE PREFERRED EMBODIMENTS

Preferred embodiments of the present invention will be described below with reference to the drawings.

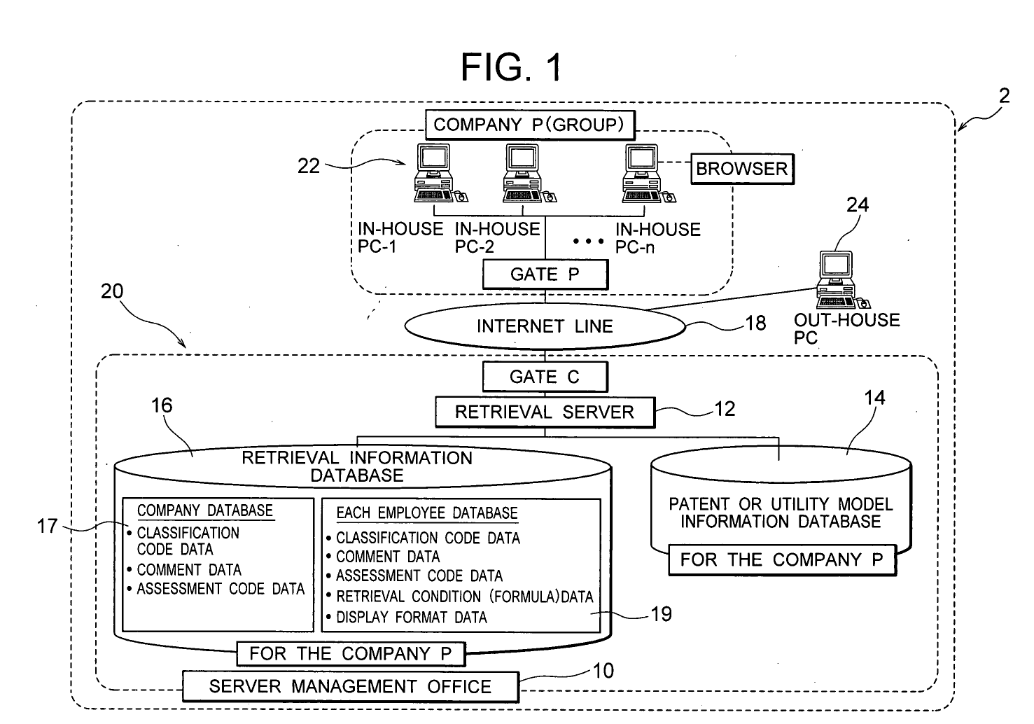

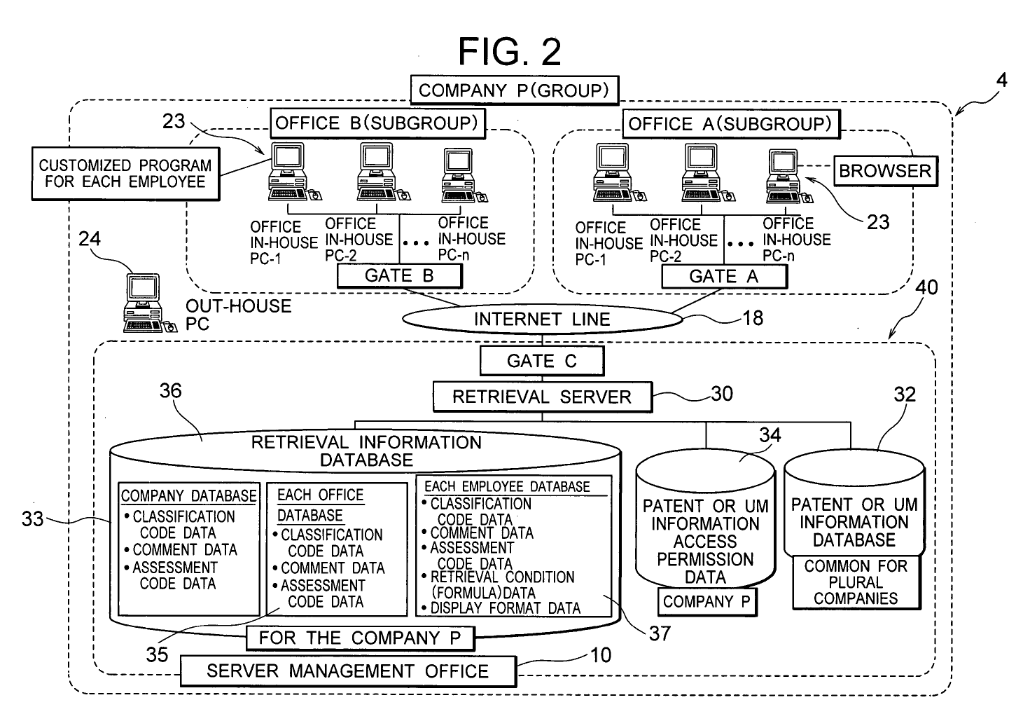

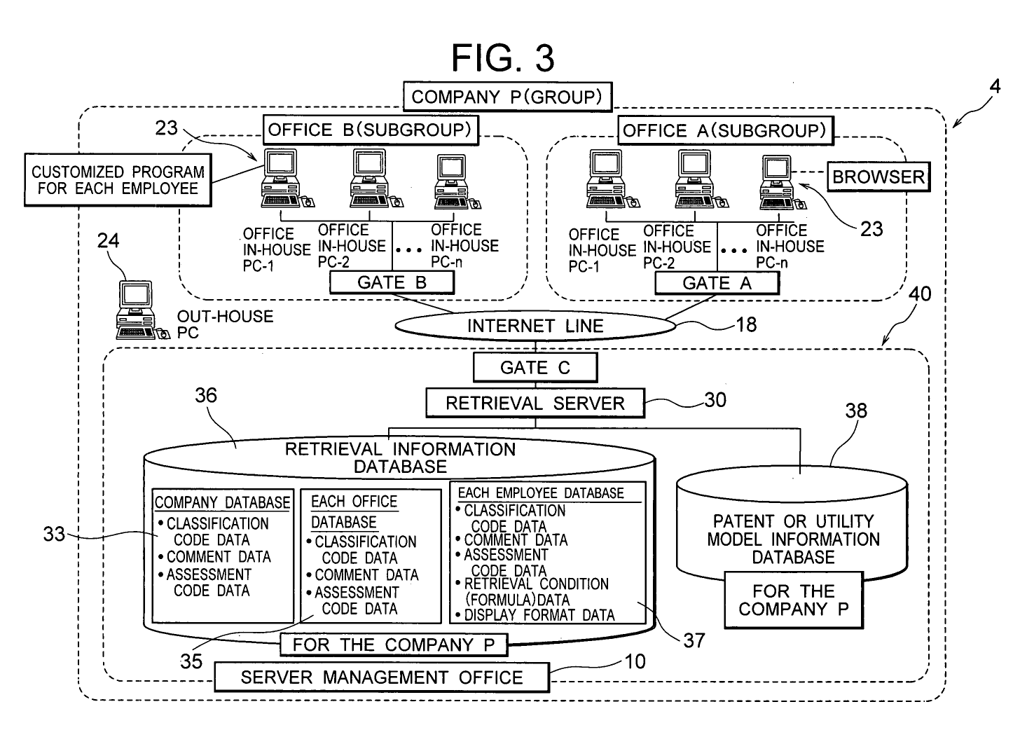

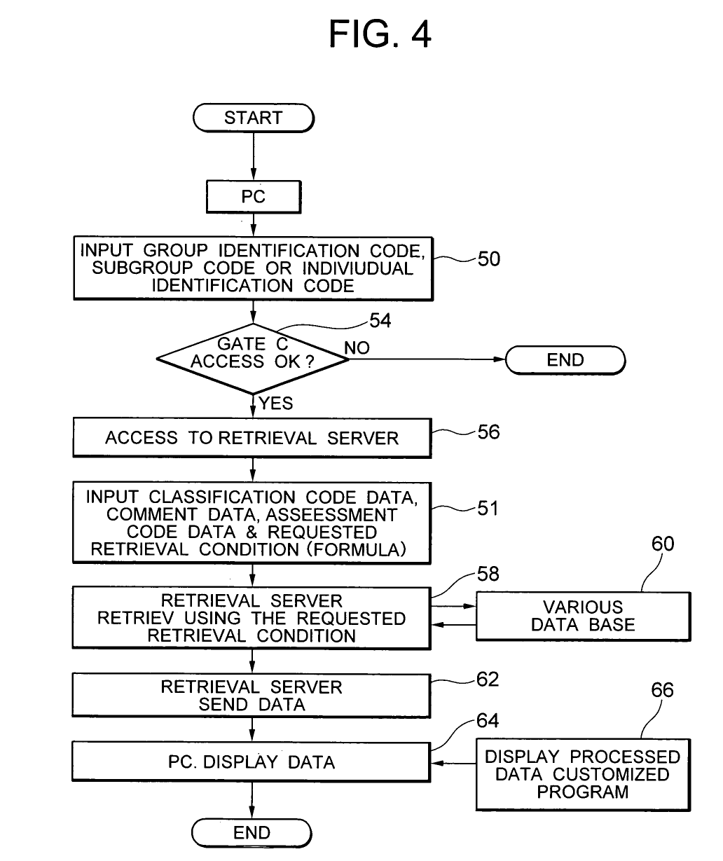

FIG. 1 is a diagram for schematically showing the configuration of a management system of patent or utility model information retrieval by Internet according to the first embodiment of the present invention, FIG. 2 is a diagram for schematically showing the configuration of a management system of patent or utility model information retrieval by Internet according to the second embodiment of the present invention, FIG. 3 is a diagram for schematically showing the configuration of a management system of patent or utility model retrieval by Internet according to the third embodiment of the present invention, and FIG. 4 is a flowchart for showing a retrieving sequence in a management system of patent or utility model retrieval by Internet according to the present invention. Note that in the description of each of the embodiments, a “group” is corresponding to a “company”, a “subgroup” is to an “office”, and an “individual” to an “employee”, respectively, in terms of the meanings.

Referring to FIG. 1, a server management office 10 is provided with a retrieval server 12. The retrieval server 12 is connected to an information data base 14 of patent or utility model information for a contract company (e.g. Company P), a retrieval information data base 16 for Company P and a gate C which is connected to an Internet line 18, so as to constitute an information retrieval system 20 of patents and utility models.

The retrieval information data base 16 comprises at least one of a data base 17 for the company and a data base 19 for an employee. The data base 17 for a company stores therein classification code data for the company, comment data for the company and assessment code data for the company, while the data base 19 for an employee stores therein classification code data for each employee, comment data for each employee, assessment code data for each employee, retrieval condition (formula) data for each employee, and display format data for each employee. Then, the retrieval information data base 16 comprises at least one of the several kinds of retrieval data described above.

On the other hand, in Company P, each in-house personal computer PC 22 (in-house PC-1, in-house PC-2, and so on) is connected to the Internet line 18 via a gate P. A user can access to the retrieval server 12 by inputting an employee or company identification code into the in-house personal computer PC 22. Also, when an employee of Company P utilizes the system from outside the company, the employee can also access to the retrieval server 12 by inputting the employee or company identification code into an out-house personal computer PC 24 which is directly connected to the Internet line.

As described above, it is possible to structure the management system 2 of patent or utility model information retrieval by the use of the Internet by connecting the information retrieval system 20 of patent or utility model information of the server management office 10 and the in-house personal computer PC 22 of Company P to each other by the Internet line 18 via the gates C and P, or directly accessing to the Internet line 18 via the out-house personal computer PC 24.

The server management office 10 registers, for each piece of the patent or utility model information acquired upon request of a contract company (e.g. Company P), at least one of the classification code data for the company, the comment data for the company, the assessment code data for the company, the classification code data for each employee, the comment data for each employee and the assessment code data for each employee as the retrieval data, in the retrieval information data base 16. Also, in the information data base 14 of a patent or a utility model, the information of said patent or utility model is registered. The retrieval data and the information of said patent or the utility model are linked together by a patent number, or the like. As a result, it is rendered possible for the retrieval server 12, upon retrieval request by an employee of Company P, to retrieve and extract the information of the applied patent or utility model information from the retrieval information data base 16 and the patent or utility model information data base 14, thereby indicating the retrieved and extracted information on the personal computer PC 22 or personal computer PC 24 of the requesting employee. To the patent or utility model information displayed on the personal computer PC 22 or personal computer PC 24, each employee can newly attach the classification code data for the company, the comment data for the company, the assessment code data for the company, the classification code data for each employee, the comment data for each employee or the assessment code data for each employee to store the same in the retrieval information data base 16, or can store the display retrieval condition (formula) data for each employee and the display format data for each employee in the retrieval information data base 16. As described, by attaching the classification code which is original with the company (user), it is rendered possible to obtain a retrieval result with high reliability in accordance with the criteria original with the company.

Note that, in the first embodiment, description was made on the patent or utility model information management system by Internet to be used by one company. However, the system of the first embodiment can be used for patent or utility model information retrieval for a plurality of companies.

FIG. 2 shows the second embodiment according to the present invention. The second embodiment represents a case that a plurality of subgroups (Office A, Office B) in the same company (e.g. Company P) each has the in-house personal computers PC 23. A retrieval server 30 of the server management office 10 is provided with a patent or utility model information data base 32 shared by the plurality of companies, a patent or utility model information access permission data 34 for Company P which stores therein an information list of a patent or a utility model information required by Company P, and a retrieval information data base 36 for Company P. The retrieval server 30 is connected to the Internet line 18 via the gate C to constitute a patent or utility model information retrieval system 40. The patent or utility model information access permission data 34 for Company P is provided, when the patent or utility model information data base 32 stores therein patent or utility model information of a plurality of companies, to extract only the patent or utility model information which is required by Company P, by which enhancement or the like of the retrieving efficiency is intended.

Note that if there is a small number of the companies for sharing the information and there is no performance problem with the retrieval server 30 with respect to the retrieving efficiency or the like, the patent or utility model information access permission data 34 is no longer required.

The retrieval information data base 36 contains at least one of a data base 33 for the company, a data base 35 for each office, and a data base 37 for each employee 37. The data base 33 for the company stores therein the classification code data for the company, the comment data for the company and the assessment code data for the company, the data base 35 for each office stores therein the classification code data for each office, the comment data for each office and the assessment code data for each office, and the data base 37 for each employee stores therein the classification code data for each employee, the comment data for each employee and the assessment code data for each employee, the retrieval condition (formula) data for each employee, and the display format data for each employee. Then, the retrieval information data base 36 contains at least one of the foregoing kinds of retrieval data.

On the other hand, in Company P (group), each in-house personal computer PC 23 of each office (subgroup) is connected to the gates A or B connected to the Internet line 18. The user can access to the retrieval server 30 by inputting an employee or office or company an identification code into the personal computer PC 23 of each office. Also, when an employee of Company P is to access to this server 30 from outside the company, the employee may access to the retrieval server 30 by inputting an employee or office or company identification code into the out-house personal computer PC 24 which is directly connected to the Internet line.

As described above, when the patent or utility model information retrieval system 40 of the server management office 10 and the in-house personal computer PC 23 of Company P are connected to the Internet line 18 through the gates A, B, C, or are connected to the Internet line 18 through the out-house personal computer PC 24 directly, the patent or utility model information retrieval management system 4 by Internet can be structured.

Note that, in the above description, connection to the Internet line 18 is executed through the respective gates A and B. However, the gates A and B may be connected to each other and the connection to the Internet line 18 may be executed through either one of the gates A and B. Also, another gate D (not shown) may be provided so that the gates A and B may be connected to the Internet line through the gate D.

The server management office 10 acquires, upon request of each office of Company P, data such as patent or utility model information from the Patent Office, or the like, and registers in the retrieval information data base 36 as a retrieval data at least one of classification code data shared by a group, comment data shared by the group, assessment code data shared by the group, classification code data shared by a subgroup, comment data shared by the subgroup, assessment code data shared by the subgroup, classification code data for each employee, comment data for each employee, and assessment code data for each employee all of which are given for each acquired piece of the patent or utility model information. Also, in the patent or utility model information data base 32, the information of the applied patent or utility model is registered. The search data and the information of the applied patent or utility model are linked to each other by the patent numbers, or the like. As a result, it is rendered possible for the retrieval server 30 to retrieve and extract the information of an applied patent or utility model, upon request of retrieve, from the retrieval information data base 36 of Company P, the patent or utility model information of access permission data 34 of Company P, and the patent or utility model information data base 32, and to display the information on the personal computer PC 23 or personal computer PC 24 of the user.

It is also possible for each employee to newly attach the classification code data shared by a group, the comment data shared by the group, the assessment code data shared by the group, the classification code data shared by a subgroup, the comment data shared by the subgroup, the assessment code data shared by the subgroup, the classification code data for each employee, the comment data for each employee and the assessment code data for each employee to the patent or utility model information displayed on the personal computer PC. 23 or personal computer PC 24 and store the same in the retrieval information data base 36, or to store the retrieval condition (formula) data for each employee and the display format data for each employee in the retrieval information data base 36.

As described above, in the system shown in FIG. 2, it is rendered possible to provide quick information retrieval service of a patent or a utility model by the use of one integrated patent or utility model information retrieval system 40 to a plurality of subgroups.

Note that in the above description of the second embodiment, the patent or utility model information management system by Internet for a plurality of offices of the same company was illustrated. However, in the system of the second embodiment, the patent or utility model information retrieval service for a plurality of companies can be provided in the same manner.

FIG. 3 shows the third embodiment of the present invention. The third embodiment is different from the second embodiment in that the patent or utility model information data base 32 used in common by a plurality of companies is replaced with a patent or utility model information data base 38 for the exclusive use of one company (Company P). Consequently, the patent or utility model information access permission data 34 of Company P, which is provided in the second embodiment, is no longer required. The other arrangements are the same as those of the second embodiment, so that the same constituent parts are given the same referential numerals and symbols and detailed description thereof will be omitted.

Next, description will be made on a retrieval procedure of patent or utility model information in the patent or utility model information retrieval management system by Internet according to the present invention with reference to FIG. 4. The retrieval procedure is the same in all the first, second and third embodiments, so that the referential numerals and symbols in the second and third embodiments are given in brackets in the following description.

A group identification code is input when the retrieval system is used by a group, a subgroup identification code is input when used by a subgroup, and an individual identification code is input when used by each employee to the personal computer PC22 [23] or personal computer PC 23 [24](50). Each of the input identification codes is authenticated at the gate P [A],[B], and further each identification code is accepted at the gate C of the server management office 10 (54). Then, the user is permitted to access to the retrieval server 12 [30] of the server management office 10 [10]. In order to prevent a person who is not qualified to access or who has lost such qualification from accessing, a Company P (group) identification code may be automatically attached at the gate P, and an office (subgroup) identification code at the gates [A] or [B]. In this manner, unauthorized access by such a person not qualified to access or having lost such qualification can be prevented.

The personal computer PC 22 [23] or personal computer PC 24 [24] sends, after connecting to the retrieval server 12 [30], at least one, or a plurality of, or any combination of, the classification code data, the comment data, and assessment code data for the company, for each office and for each employee, and required retrieval condition (formula) data, and so on (51). The retrieval server 12 [30] retrieves requested patent data from the retrieval data base 16 [36] and the patent or utility model information data base 14 [32], [38] (60) on the basis of the retrieval information such as a retrieval condition (formula) requested by each employee (58), and the data is sent from the retrieval server 12 [30] to a display screen of the personal computer PC 22 [23] or personal computer PC 24 [24] of each employee (62). Each employee can correct the retrieved information, etc., when the displayed result (64) is not the desired information, to conduct another retrieval and can take out the desired patent or utility model information from the retrieval server 12 [30] of the server management office 10 [10] by repeating this step.

Also, with the patent or utility model information retrieval system 2 [4] by Internet according to the present invention, it is also possible for the user him- or her-self to add a classification code data, a comment data, an assessment code data, a retrieval condition (formula), a display format, etc., to the patent or utility mode information retrieved by the user for modification, etc., thereof and then registers the same in the retrieval information data base 16 [36]. Furthermore, with this system 2 [4], it is possible to process a display on a screen (64) for each PC by the use of a customized program, a browser, etc., (66) for each employee.

A manner of use of identification codes will be described below. In the embodiments of the present invention, three kinds of identification codes, that is, an employee (individual) identification code, an office (subgroup) identification code, and a company (group) identification code, are properly used. With the individual identification code, the retrieval server 12 [30] can recognize, besides an employee, a company by which this employee is employed, or can recognize a company as well as an office by which this employee is employed. With the subgroup identification code, the retrieval server 12 [30] can recognize the employing company, in addition to the office. With the group identification code, the retrieval server 12 [30] can recognize the company. For instance, when the employee identification code is “the employee identification code=Employee X of Office A of Company P+password”, the retrieval server 12 [30] can identify the company and the office by which this employee is employed. Also, when the employee identification code is “the employee identification code=Employee X+password”, the retrieval server 12 [30] can refers to the registered identification code information (which stores therein the company, the office, and the like, by which the employee is employed) to thereby identify the company and the office by which this user is employed. As described above, the retrieval server 12 [30] may be provided with a table for showing respective relations among the company identification codes, the office identification codes and the employee identification codes, to be properly referred to.

Next, description will be made on an example of a relation between the identification codes and access permission to each of the data bases. When the retrieval server 12 [30] can recognize the employing company with an identification code, a user having inputted this identification code can access to the data base 17 [33] for the company of the retrieval information data base 16 [30]. Also, when the retrieval server 12 [30] can recognize the employee with an identification code, a user having inputted this identification code can access to the data base 17 [33] for the company, or the data base [35] for each office, or the data base 19 [37] for each employee of the retrieval information data base 16 [30].

Note that the relation between the identification codes and the access permission can be changed properly depending on an operation of the system. A flowchart shown in FIG. 4 represents an example of a search procedure in this system, which can be changed properly upon request by the user, as a matter of course. Furthermore, in the description of this system, the patent or utility model information was exemplified. However, the system of the present invention is not limited to the retrieval of the patent or utility model information, but can be applied to other data base retrievals.

### INDUSTRIAL UTILITY

As described above, with employment of the patent or utility model information retrieval management system by Internet according to the present invention, the server management office can manage the retrieve of patent or utility mode information through the Internet line only by registering the patent or utility mode information in the patent or utility model information data base of the retrieval server of the server management office, so that it is no longer required to go to each company using the server for the maintenance thereof, unlike with a conventional system. As a result, some part of the patent management work can be omitted and the common patent or utility information data base can be shared by a large number of users, which results in curtailment of work in the management office.

Also, with the patent or utility model information retrieval management system by Internet according to the present invention, the classification code data, the comment data, the assessment code data, etc., for all of the company, the office and the employee can be registered in the retrieval information data base, so that retrieval of patent or utility model information using these pieces of retrieval information can be conducted more easily.

1. A management system of patent or utility model information retrieval by Internet, characterized in that:
a personal computer of a group or a subgroup is connected to a server of a server management office by the Internet line;
said personal computer accesses to said server;
said server has a retrieval data base containing at least one of classification code data for a group, classification code data for a subgroup, and a classification code data for an individual, as well as an information data base of patent or utility model information;
said retrieval data base and said information data base are retrieved upon request of retrieval for patent or utility model information by said personal computer and applied data of the patent or utility model information is issued to said personal computer; and
said personal computer outputs the issued data.

2. A management system of patent or utility model information retrieval by Internet, characterized in that:
a personal computer of a group or a subgroup is connected to a server of a server management office by the Internet line;
an identification code of said group or an identification code of said subgroup is automatically assigned at a gate of said group or said subgroup;
the identification code of said group or the identification code of said subgroup is accepted at a gate of said server management office;
said server of said server management office recognizes the identification code of said group or the identification code of said subgroup;
whereupon said personal computer accesses to said server;
said server has a retrieval data base containing at least one of classification code data for a group, comment data for a group, assessment code data for a group, classification code data for a subgroup, comment data for a subgroup, assessment code data for a subgroup, classification code data for an individual, comment data for an individual, and assessment code data for an individual, as well as an information data base of patent or utility model information;
said retrieval data base and said information data base are retrieved upon request of retrieval for patent or utility model information by said personal computer and applied data of the patent or utility model information is issued to said personal computer; and
said personal computer outputs the issued data.

3. A management system of patent or utility model information retrieval by Internet, characterized in that:
a personal computer of a group or a subgroup is connected to a server of a server management office by the Internet line;
said personal computer accesses to said server;
said server has a retrieval data base containing at least one of classification code data for a group, comment data for a group, assessment code data for a group, classification code data for a subgroup, comment data for a subgroup, assessment code data for a subgroup, classification code data for an individual, comment data for an individual, and assessment code data for an individual, as well as an information data base of patent or utility model information;
said retrieval data base and said information data base are retrieved upon request of retrieval for patent or utility model information by said personal computer and applied data of the patent or utility model information is issued to said personal computer; and
said personal computer outputs the issued data.
